(19) United States
(12) Patent Application Publication
(10) Pub. No.: US 2026/0230524 A1
(43) Pub. Date: Aug. 6, 2026

(54) Layer-Separated Transport and RDMA

(71) Applicant: Mellanox Technologies, Ltd., Yokneam (IL)

(72) Inventor: Ariel Shahar, Jerusalem (IL)

(21) Appl. No.: 19/044,654

(22) Filed: Feb. 4, 2025

(51) Int. Cl. H04L 67/1097; H04L 1/1607

(52) U.S. Cl. CPC H04L 67/1097; H04L 1/1621

(57) ABSTRACT

A communication system includes first and second network devices. The first network device includes (i) an RDMA initiator, to generate an RDMA message that includes one or more packets and specifies an RDMA operation, and (ii) a transport requestor, to send the one or more packets over a network via one or more transport connections. The second network device includes (i) a transport responder, to receive the one or more packets from the network via the one or more transport connections, and (ii) an RDMA target, to receive the RDMA message and execute the RDMA operation. The transport responder sends acknowledgements indicating successful reception of the packets, the acknowledgements sent independently of successful reception of the RDMA message. The RDMA target sends a confirmation indicating successful reception of the RDMA message, in addition to the acknowledgements.

### TECHNICAL FIELD

The present disclosure relates generally to network communication, and particularly to communication using separated transport and RDMA layers.

### BACKGROUND

Remote Direct Memory Access (RDMA) is a protocol that enables reading and writing data in a memory of a remote host without involving the remote host's software. The RDMA protocol may operate over various types of transport protocols, e.g., over InfiniBand™ (IB) Reliable Connection (RC).

### SUMMARY

An embodiment that is described herein provides a communication system including a first network device and a second network device. The first network device includes (i) a Remote Direct Memory Access (RDMA) initiator, to generate an RDMA message that includes one or more packets and specifies an RDMA operation, and (ii) a transport requestor, to send the one or more packets over a network via one or more transport connections. The second network device includes (i) a transport responder, to receive the one or more packets from the network via the one or more transport connections, and (ii) an RDMA target, to receive the RDMA message conveyed by the one or more packets and execute the RDMA operation. The transport responder is to send, to the first network device, one or more acknowledgements indicating successful reception of the one or more packets, the acknowledgements being sent independently of successful reception of the RDMA message by the RDMA target. The RDMA target is to send to the first network device a confirmation indicating the successful reception of the RDMA message, in addition to the acknowledgements sent by the transport responder.

In some embodiments, the transport requestor is to retransmit at least one of the packets, in response to the acknowledgements and irrespective of the confirmation. In some embodiments, the RDMA initiator is to retransmit at least part of the RDMA message, in response to the confirmation and irrespective of the acknowledgements.

In a disclosed embodiment, the RDMA target is to determine whether all the one or more packets associated with the RDMA message were received successfully, by maintaining a count of received packets associated with the RDMA message and comparing the count to an expected size of the RDMA message. In an embodiment, the RDMA target is to determine whether all the one or more packets associated with the RDMA message were received successfully, by tracking successful arrival of portions of the RDMA message. In an example embodiment, the RDMA target is to determine whether all the one or more packets associated with the RDMA message were received successfully, irrespective of Packet Sequence Numbers (PSNs) specified in the packets.

In an embodiment, the transport requestor is to handle multiple transport connections, and the RDMA initiator is to execute multiple RDMA objects that generate multiple RDMA messages, and to interleave the packets of the multiple RDMA messages over the multiple transport connections. In an embodiment, the transport responder is to handle multiple transport connections, and the RDMA target is to execute multiple RDMA objects that receive the packets of multiple RDMA messages interleaved over the multiple transport connections and receive the multiple RDMA messages.

In some embodiments, the RDMA initiator and the RDMA target are not to protect against duplicate delivery of a packet. In an example embodiment, the RDMA target is to retire a given RDMA message in response to finding that not all the packets associated with the given RDMA message are received within a defined timeout. In an embodiment, the RDMA initiator is to report completion of the RDMA message in response to receiving both (i) the acknowledgements from the transport responder and (ii) the confirmation from the RDMA target.

In an embodiment, the transport requestor is to release packet resources upon receiving an acknowledgement from the transport responder. In an embodiment, the RDMA target is to release message resources upon receiving a transport-layer acknowledgement that acknowledges the confirmation.

There is additionally provided, in accordance with an embodiment that is described herein, a communication method including, in a first network device: (i) generating a Remote Direct Memory Access (RDMA) message that includes one or more packets and specifies an RDMA operation, and (ii) sending the one or more packets over a network via one or more transport connections. In a second network device: (i) the one or more packets are received from the network via the one or more transport connections, and (ii) the RDMA message conveyed by the one or more packets is received and the RDMA operation is executed. One or more acknowledgements, which indicate successful reception of the one or more packets, are sent from the second network device to the first network device, the acknowledgements being sent independently of successful reception of the RDMA message. A confirmation, which indicates the successful reception of the RDMA message, is sent from the second network device to the first network device in addition to the acknowledgements.

There is additionally provided, in accordance with an embodiment that is described herein, a communication method including, in an initiator network device: (i) in a Remote Direct Memory Access (RDMA) layer, generating an RDMA message that includes one or more packets and specifies an RDMA operation, and (ii) in a transport layer, sending the one or more packets over a network via one or more transport connections. In a target network device, (i) in the transport layer, receiving the one or more packets from the network via the one or more transport connections, and (ii) in the RDMA layer, receiving the RDMA message conveyed by the one or more packets, and executing the RDMA operation. The RDMA layer and the transport layer are independent of one another, both in the initiator network device and in the target network device.

The present disclosure will be more fully understood from the following detailed description of the embodiments thereof, taken together with the drawings in which:

### BRIEF DESCRIPTION OF THE DRAWINGS

FIG. 1 is a block diagram that schematically illustrates a network communication system, in accordance with an embodiment that is described herein;

FIG. 2 is a diagram that schematically illustrates exchange of messages and packets, and corresponding acknowledgements and confirmations, in the system of FIG. 1 above, in accordance with an embodiment that is described herein;

FIG. 3 is a flow chart that schematically illustrates a method for communication using separated transport and RDMA layers, in accordance with an embodiment that is described herein; and

FIG. 4 is a block diagram that schematically illustrates a computing system that employs communication using separated transport and RDMA layers, in accordance with an embodiment that is described herein.

### DETAILED DESCRIPTION OF EMBODIMENTS

### Overview

In conventional implementations of RDMA, there is considerable coupling and dependency between the RDMA layer and the underlying transport layer. In an example implementation, an initiator network device (“initiator”) composes an RDMA message for transmission to a target network device (“target”). The RDMA message specifies a certain RDMA operation to be executed in a memory coupled to the target. The initiator generates one or more packets that convey the RDMA message, and sends the packets over a network to the target. The target receives the packets and sends back acknowledgements indicating to the initiator that the packets have arrived and were handled successfully, while receiving the RDMA message and executing the RDMA operation in the memory. An acknowledgement for a packet implies that the arriving packet, and all predecessor packets, have been received successfully and conveyed to the message construction process.

The above scheme is adequate for lossless networks that guarantee in-order delivery of packets. Modern networks, however, employ mechanisms such as adaptive routing and multipathing, which cause Out-Of-Order (OOO) packet delivery. In such networks, as well as in lossy networks, the coupling between the RDMA layer and the transport layer is problematic.

Embodiments that are described herein provide improved techniques for communicating RDMA messages. In the present context, the term “RDMA” also includes protocols such as RDMA over Converged Ethernet (RoCE). The disclosed techniques provide complete separation between the RDMA layer and the transport layer. In particular, the initiator network device and the target network device apply two separate and independent delivery-feedback mechanisms, one at the packet level (as part of the transport layer) and one at the RDMA message level (as part of the RDMA layer).

In an example embodiment, the target network device sends back two types of delivery-feedback indications, independently of one another:
Transport-layer Acknowledgements indicating successful reception of packets. An acknowledgement for a packet is sent regardless of whether the packet was associated with the RDMA message successfully or not, and in general regardless of the status of processing the RDMA message by the RDMA layer.
RDMA-layer confirmations indicating successful or unsuccessful reception of RDMA messages. In the present context, an RDMA message is considered “successfully received” when (i) the (one or more) packets conveying the RDMA message are received successfully, and (ii) the corresponding memory access operations in the target have been completed. A confirmation for an RDMA message is sent in addition to the (one or more) acknowledgements of the (one or more) packets conveying the RDMA message.

The separation between the RDMA layer and the transport layer provides considerable advantages. First and foremost, RDMA messages can be transmitted efficiently over lossy networks and networks that do not guarantee in-order packet delivery. For example, the transport layer in the initiator and target network devices may identify lost or delayed packets, and initiate retransmissions, with very short response times. Immediate generation of acknowledgement also improves the efficiency of packet-associated resources allocation and the accuracy of Round-Trip Time (RTT) measurements.

Second, an RDMA message can be split among multiple separate and independent transport entities, utilizing more of the network available resources, increasing the rate of packet generation and acceptance, and shortening the latency of RDMA message delivery.

Moreover, multiple RDMA entities can use a given transport connection, without the risk of a poorly functioning RDMA entity affecting other RDMA entities that share the same transport. Sharing transport connections by multiple RDMA entities is highly important for scalability.

Furthermore, to determine whether all the packets associated with a given RDMA message have arrived, the RDMA layer of the target network device does not need to be aware of the expected Packet Sequence Numbers (PSNs) of the packets. Instead, the RDMA layer may count the number of received packets that are associated with the RDMA message, and compare this number to an expected count. The transport layer is typically responsible for blocking duplicate packets, relieving the RDMA layer of this requirement.

### System Description

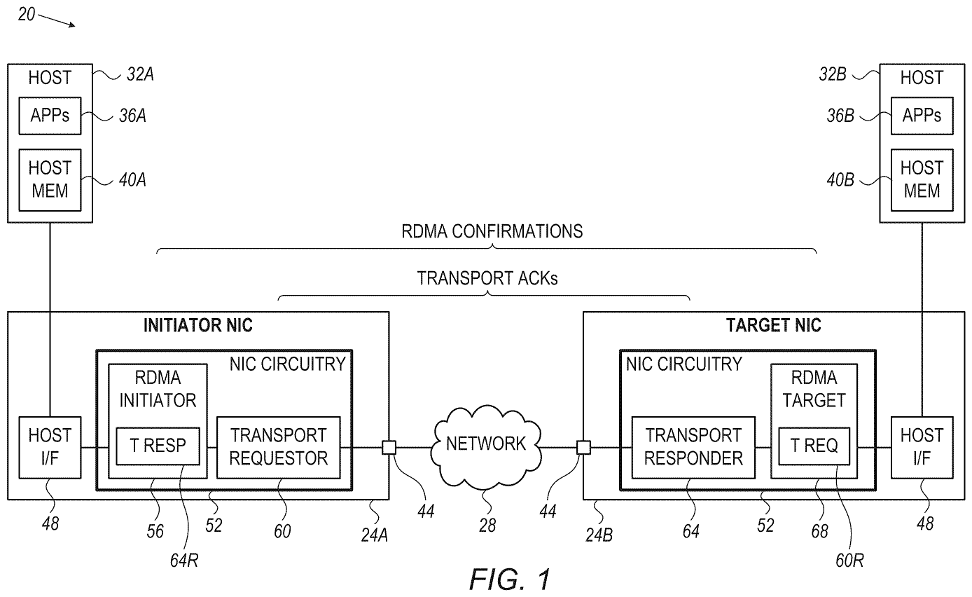

FIG. 1 is a block diagram that schematically illustrates a network communication system 20, in accordance with an embodiment that is described herein. System 20 comprises a pair of network devices denoted 24A and 24B, which communicate over an IB network 28. In the embodiment of FIG. 1, network devices 24 are referred to as Network Interface Controllers (NICs). Generally, however, the disclosed techniques can be implemented in other suitable types of network devices, such as Host Channel Adapters (HCAs) and Data Processing Units (DPUs).

NIC 24A serves a host 32A that runs one or more applications (“apps”) 36A and comprises a host memory 40A. NIC 24B serves a host 32B that runs one or more applications 36B and comprises a host memory 40B.

In the present example, NIC 24A sends RDMA messages, which specify RDMA operations to be executed by NIC 24B. For example, NIC 24A may initiate an RDMA WRITE message that transfers data from one of apps 36A to host memory 40B, via NICs 24A and 24B. As another example, NIC 24A may initiate an RDMA READ message that reads data directly from host memory 40B, using NIC 24B, and transfers the data to one of apps 36A vis NIC 24A. In both cases the data transfer does not involve software on host 32B. In the present context, NIC 24A is referred to as an “initiator NIC” and NIC 24B is referred to as a “target NIC”.

Initiator NIC 24A comprises one or more ports 44 for communicating with network 28, a host interface (I/F) 48 for communicating with host 32A, and NIC circuitry 52 that carries out the various processing tasks of the NIC. NIC circuitry 52 comprises an RDMA initiator 56 and a transport requestor 60. RDMA initiator 56 carries out RDMA-layer initiator-side tasks. Transport requestor 60 carries out transport-layer requestor-side tasks. In some embodiments, RDMA initiator 56 and transport requestor 60 are implemented in hardware and are controlled by software or firmware.

Target NIC 24B also comprises one or more ports 44 for communicating with network 28, a host interface (I/F) 48 for communicating with host 32A, and NIC circuitry 52 that carries out the various processing tasks of the NIC. NIC circuitry 52 comprises a transport responder 64 and an RDMA target 68. Transport responder 64 carries out transport-layer responder-side tasks. RDMA target 68 carries out RDMA-layer target-side tasks. In some embodiments, transport responder 64 and RDMA target 68 are implemented in hardware and are controlled by software or firmware.

Typically, NICs 24A and 24B are similar or identical in design, and their roles as initiator or target are logical. A given NIC can typically serve as an initiator for one or more RDMA messages and as a target for one or more RDMA messages, possibly concurrently. For the sake of clarity, FIG. 1 focuses on the initiator-related elements of NIC 24A and on the target-related elements of NIC 24B.

Among other tasks, NIC circuitries 52 of NICs 24A and 24B apply two separate and independent delivery-feedback mechanisms. One mechanism is a transport-layer mechanism, which is carried out between transport requestor 60 and transport responder 64 and uses packet-level acknowledgements. The other mechanism is an RDMA-layer mechanism, which is carried out between RDMA initiator 56 and RDMA target 68 and uses message-level confirmations. The two delivery-feedback mechanisms, and the resulting independence between the RDMA layer and the transport layer, are described in detail below.

In the embodiment of FIG. 1, RDMA target 68 comprises an internal transport requestor 60R (also referred to as a reverse transport requestor), and RDMA initiator 56 comprises a transport responder 64R (also referred to as a reverse transport responder). Transport requestor 60R and transport responder 64R are responsible for exchanging the message-level confirmations.

In some embodiments, the transport layer (e.g., transport requestor 60 and/or transport responder 64) is configured to prevent delivery of duplicate copies of the same packet, i.e., to ensure that each packet is delivered no more than once. As such, the RDMA layer (e.g., RDMA initiator 56 and/or RDMA target 68) is not required to check for and avoid duplicate copies of a packet.

The configurations of system 20 and its components, e.g., network devices 24A and 24B, as depicted in FIG. 1, are example configurations that are chosen purely for the sake of conceptual clarity. Any other suitable configurations can be used in alternative embodiments.

In various embodiments, network devices 24A and 24B may be implemented using suitable software, using suitable hardware such as one or more Application-Specific Integrated Circuits (ASIC) or Field-Programmable Gate Arrays (FPGA), or using a combination of hardware and software.

Some elements of network devices 24A and 24B may be implemented using one more general-purpose processors, which are programmed in software to carry out the techniques described herein. The software may be downloaded to the processors in electronic form, over a network, for example, or it may, alternatively or additionally, be provided and/or stored on non-transitory tangible media, such as magnetic, optical, or electronic memory.

### Separation Between RDMA and Transport Layers

A typical flow of an RDMA message begins with a request from an application 36A in host 32A to write or read data to or from memory 40B of host 32B. Upon receiving the request, RDMA initiator 56 in initiator NIC 24A composes an RDMA message, e.g., an RDMA READ, RDMA WRITE, SEND or ATOMIC REQUEST. RDMA initiator 56 generates one or more packets that convey the RDMA message, and provides the packets to transport requestor 60. Transport requestor 60 sends the packets over network 28 to target NIC 24B. In target NIC 24B, transport responder 64 receives the packets and forwards them to RDMA target 68. RDMA 68 receives the RDMA message and executes the RDMA operation specified in the message, e.g., writes the data to host memory 40B or reads the data from host memory 40B. RDMA 68 typically does not buffer the entire RDMA message, which may be very large, but rather accesses host memory 40B on a packet-by-packet basis.

In some embodiments, as part of the above process, target NIC 24B sends two types of delivery-feedback indications to initiator NIC 24A, one type referred to as “acknowledgements” and the other type referred to as “confirmations”.

Transport-layer Acknowledgements (“ACKs”). ACKs are sent from transport responder 64 to transport requestor 60, and are indicative of successful reception of packets. Transport responder 64 sends an ACK for a certain packet regardless of whether the packet was successfully received by the RDMA layer (for example, successfully put into memory), and regardless of the processing status of the associated RDMA message (the RDMA message with which the packet is associated) by RDMA target 68. In many cases, transport responder 64 sends an ACK for a packet before all the packets of the RDMA message have a chance to arrive, and thus before RDMA target 68 has received the entire RDMA message.

RDMA-layer confirmations. RDMA-layer confirmations (also referred to simply as “confirmations”) are sent from RDMA target 68 to RDMA initiator 56, indicating successful or unsuccessful reception of RDMA messages. As noted above, in the present context the term “successful reception” of an RDMA message includes successful access to the host memory. RDMA target 68 sends, using reverse transport requester 60R, a confirmation for an RDMA message in addition to the (one or more) ACKs that are sent by transport responder 64 for the (one or more) packets conveying the same RDMA message. RDMA initiator 56 receives the confirmation using reverse transport responder 64R, and acknowledges the confirmation by a transport ACK.

In the present context, the term “acknowledgement” includes both positive acknowledgements (indicating that a packet was received successfully) and negative acknowledgements (indicating that a packet was not received successfully). A given acknowledgement may pertain to a single packet or to multiple packets. Similarly, the term “confirmation” includes both positive confirmations (indicating that a message was received successfully) and negative confirmations (indicating that a message was not received successfully). A given confirmation may pertain to a single message or to multiple messages.

In some embodiments, each of the two delivery-feedback mechanisms is coupled with a respective retransmission mechanism. The two retransmission mechanisms belong to different layers, and are separate and independent of one another. In the transport layer, transport requestor 60 may retransmit a packet in response to the acknowledgments (e.g., in response to not receiving a positive ACK for the packet, or in response to receiving a negative ACK for the packet). Retransmission of a packet is independent of any of the RDMA-layer confirmations that may or may not be received. In the RDMA layer, RDMA initiator 56 may retransmit at least part of an RDMA message in response to a confirmation (e.g., in response to not receiving a positive confirmation for the message, or in response to receiving a negative confirmation for the message).

### Example Message Exchange

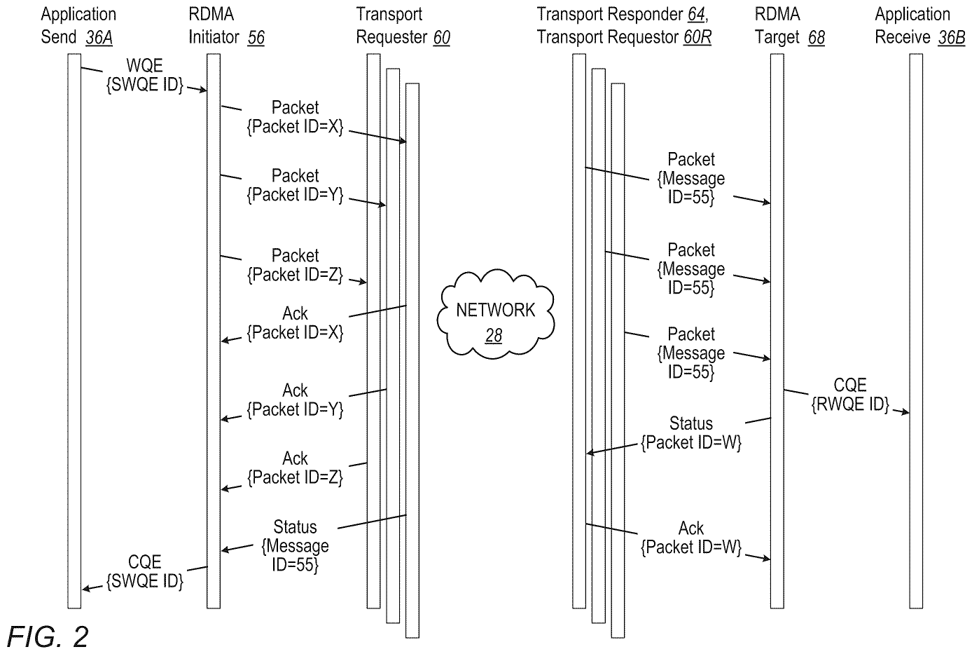

FIG. 2 is a diagram that schematically illustrates exchange of messages and packets, and corresponding acknowledgements and confirmations, in accordance with an embodiment that is described herein. In the example of FIG. 2, one of applications 36A (on host 32A) initiates an RDMA message that specifies an RDMA operation to be executed in host memory 40B of host 32B. Application 36A instructs initiator NIC 24A to send the RDMA message by posting a Work Queue Element (WQE) on a Work Queue (WQ) of NIC 24A. The WQE has an identifier denoted SWQE ID.

In response to the WQE, RDMA initiator 56 in NIC 24A generates an RDMA message that spans three packets. RDMA initiator 56 provides the three packets to transport requestor 60. RDMA initiator 56 identifies the packets to transport requestor 60 using transport-layer packet identifiers denoted PACKET_ID=X, PACKET_ID=Y and PACKET_ID=Z. Transport requestor 60 sends the three packets over network 28 to target NIC 24B.

In sending the packets, transport requestor 60 attaches a respective Packet Sequence Number (PSN) to each packet. In the present example, the packet having PACKET_ID=X is sent with PSN=1, the packet having PACKET_ID=Y is sent with PSN=2, and the packet having PACKET_ID=Z is sent with PSN=3. Transport requestor 60 may select any order of assignment of PACKET_IDs and PSNs, but it should record the association of PSNs to PACKET_IDs for future correlation with received ACKs.

In target NIC 24B, the three packets are provided to transport responder 64. For each packet that is received successfully, transport responder 64 sends an ACK with the respective PSN over network 28, back to initiator NIC 24A. Transport responder 64 can coalesce multiple ACKs and send only the last PSN of the ACKs, thus acknowledging preceding packets as well. Note that transport responder 64 sends an ACK for a packet regardless of the processing status of the packet in the RDMA layer. The three ACKs are indicative, using their PSNs, of the respective IDs of the packets that they acknowledge (PACKET_ID=X, PACKET_ID=Y and PACKET_ID=Z). Transport requestor 60 in initiator NIC 24A forwards the ACKs to RDMA initiator 56, using the PACKET_IDs provided by the latter.

In addition to sending the transport-layer ACKs, transport responder 64 provides the three packets to RDMA target 68 in NIC 24B. Transport responder 64 identifies the packets to RDMA target 68 using an RDMA-layer message identifier MESSAGE_ID=55. The message ID indicates the RDMA message to which the packets belong. RDMA target 68 receives the three packets belonging to message ID=55, and executes the corresponding RDMA operation, packet by packet, in host memory 40B.

In some embodiments, RDMA target 68 determines whether all the packets associated with the RDMA message have arrived, by counting the packets having MESSAGE_ID=55. When the number reaches the expected number of packets in the RDMA message (3 in the present example) RDMA target 68 determines completion of the RDMA message. The expected number of packets in the RDMA message is typically reported by RDMA initiator 56 in at least one of the packets (e.g., in all packets) of the message. In this manner, the RDMA target has no need to be aware of, or track, the PSNs of the packets belonging to each RDMA message. In some cases the RDMA target has no way of tracking PSNs, since the RDMA message may be transported over multiple different transport connections having separate PSN sequences.

Alternatively or additionally to counting packets, RDMA target 68 may track the different portions of the RDMA message being received, and record indications of the successfully-received parts of the message in the message layer. The different portions of the RDMA message can be tracked, for example, in terms of their offsets from the beginning of the message (which are in turn indicative of their locations in host memory 40B).

Upon successful reception of the RDMA message, RDMA target 68 executes the corresponding RDMA operation in host memory 40B. As explained above, RDMA target 68 typically executes the RDMA operation per received packet, without buffering the entire RDMA message. In case of an RDMA WRITE, for example, RDMA target 68 writes the data that was conveyed in the RDMA message, packet by packet, to a designated address buffer in host memory 40B. In case of an RDMA READ, RDMA target 68 reads data from a designated address buffer in host memory 40B and sends the data back to initiator NIC 24A, packet by packet, using reverse transport requestor 60R.

After completing execution of the RDMA operation, RDMA target 68 may report the completion by posting a Completion Queue Element (CQE) on a Completion Queue (CQ). Typically, CQE is generated only for certain types of RDMA messages, e.g., RDMA_WRITE_WITH_IMMEDIATE and the various types of SEND messages. The CQE has an identifier denoted RWQE ID. The CQE is read by one of applications 36B on host 32B.

Upon successfully receiving the RDMA message, RDMA target 68 sends an RDMA-layer confirmation to RDMA initiator 56. The confirmation is denoted “Status” in FIG. 2. RDMA target 68 provides the RDMA-layer confirmation in a single Status packet to transport requestor 60R. RDMA target 68 identifies the Status packet to transport requestor 64R by a PACKET_ID=W. Transport requestor 64 sends the Status packet over network 28 to transport responder 60R in initiator NIC 24A, in the present example using PSN=8.

Upon receiving the Status packet, transport responder 60R sends a transport-layer ACK for the Status packet to transport requestor 64R in target NIC 24B. The ACK has the same PSN=8 as the Status packet it acknowledges, thereby indicating delivery of PACKET_ID=W. Transport requestor 64R reports the ACK to RDMA target 68 using PACKET_ID=W.

In addition to acknowledging the Status packet to transport requestor 64R, transport responder 60R also notifies RDMA initiator 56 that the Status packet has been received. The notification carries the MESSAGE_ID of the RDMA message, i.e., MESSAGE_ID=55.

In some embodiments, RDMA initiator 56 reports completion of the RDMA message in response to receiving both (i) the transport-layer acknowledgements for the packets of the RDMA message from transport responder 64 and (ii) the confirmation from RDMA target 68.

In response to the notification, RDMA initiator 56 reports completion of the RDMA message by posting a CQE on a CQ. The CQE has an identifier denoted SWQE ID. The CQE is read by application 36A that initiated the RDMA message.

In some embodiments, the transport-layer ACKs and the RDMA layer confirmations are also used as a trigger for releasing resources. For example, a transport requestor (60 or 60R) may release packet resources upon receiving an ACK for a packet from a transport responder (64 or 64R). As another example, RDMA target 68 may release message resources upon receiving the transport-layer ACK that acknowledges the RDMA confirmation (the “Status” packet).

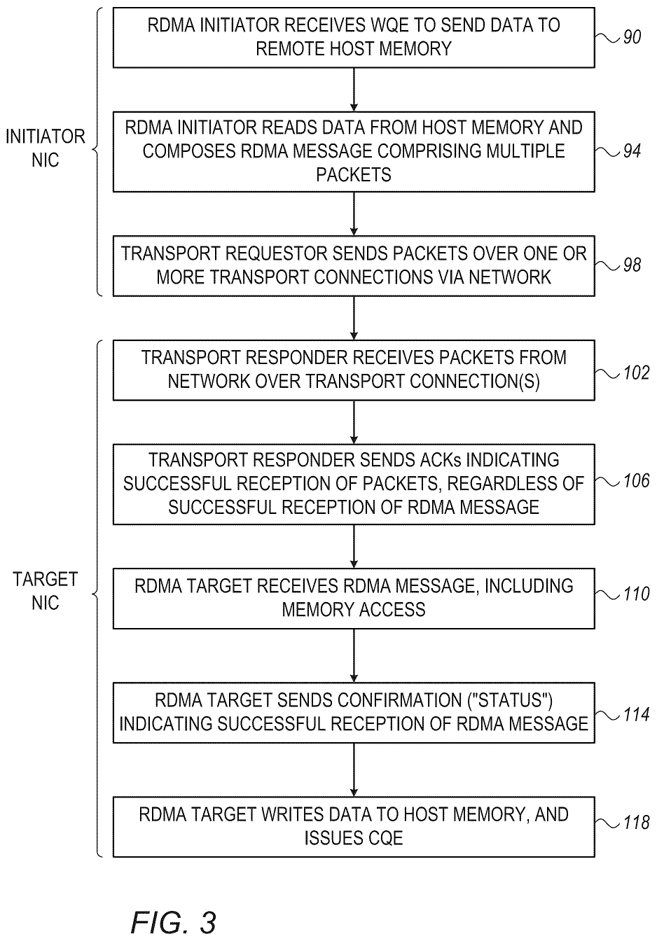

FIG. 3 is a flow chart that schematically illustrates a method for communication using separated transport and RDMA layers, in accordance with an embodiment that is described herein. The embodiment of FIG. 3 refers to an RDMA WRITE message that spans multiple packets, by way of non-limiting example. Stages 90-98 of the method are carried out by initiator NIC 24A. Stages 102-118 are carried out by target NIC 24B.

The method begins with RDMA initiator 56 receiving a WQE from an application 36A on host 32A, at a WQE reception stage 90. The WQE specifies a data buffer to be written to a specified address range in host memory 40B of host 32B. At a message preparation stage 94, RDMA initiator 56 reads the data buffer from host memory 40A, and composes an RDMA message comprising multiple packets that carry the data. At a transmission stage 98, transport requestor 60 sends the packets to target NIC 24B over one or more transport connections via network 28.

At a reception stage 102, transport responder 64 receives the packets via the transport connection(s). At a transport-layer acknowledgement stage 106, transport responder 64 sends a respective transport-layer ACK for each packet that was received successfully. The transport-layer ACKs are sent irrespective of (and often before) successful reception (including memory access) of the RDMA message.

At a message reception stage 110, RDMA target 68 receives the RDMA message conveyed by the received packets, and performs the corresponding memory access operations in host memory 40B. At an RDMA-layer confirmation stage 114, RDMA target 68 sends an RDMA confirmation (“Status”) that indicates successful reception of the RDMA message. At a memory writing stage 118, RDMA target 68 writes the data to the specified address range in host memory 40B. RDMA target 68 writes the data packet by packet, e.g., on reception of each packet.

The flow of FIG. 3 is a simplified flow that is depicted purely for the sake of conceptual clarity. Various other suitable flows can be used in alternative embodiments. For example, in some embodiments RDMA target 68 may retire a given RDMA message if not all the packets of the message arrive within a specified timeout. Certain operations (e.g., retransmissions, and transport-layer acknowledgement of the Status packet) have been omitted from the figure for the sake of clarity.

### Handling Multiple Transport and/or RDMA Objects

The embodiments described up to this point referred to processing of a single RDMA message, for the sake of clarity. In many real-life scenarios, however, it is highly advantageous to use the disclosed techniques to interleave packets of multiple RDMA messages over multiple transport connections.

In an example embodiment, transport requestor 60 in initiator NIC 24A handles multiple transport connections. The multiple transport connections may connect to any desired number of target NICs 24B. RDMA initiator 56 in initiator NIC 24A handles multiple RDMA objects that generate multiple RDMA messages simultaneously. RDMA initiator 56 sends the packets of the different RDMA messages over the multiple transport connections. RDMA initiator 56 may choose a transport connection for a given packet based on, for example, the target NIC to which the message is destined, the priority (e.g., Quality-of-Service class) of the message or packet, etc.

In an example embodiment, transport responder 64 in target NIC 24B handles multiple transport connections. The multiple transport connections may connect to any desired number of initiator NICs 24A. RDMA target 68 in target NIC 24B handles multiple RDMA objects for receiving multiple RDMA messages simultaneously. RDMA target 68 receives the packets of the different RDMA messages over the multiple transport connections and executes the corresponding RDMA operations.

In such embodiments (i) a given transport connection may convey packets that belong to different RDMA messages and are interleaved with one another, and (ii) the packets of a given RDMA message may be distributed among multiple transport connections.

The separation between the transport-layer acknowledgment mechanism and the RDMA-layer confirmation mechanism, ensures that a poorly functioning RDMA object does not affect the performance of other RDMA objects that share the same transport connection.

### Example System Use-Case

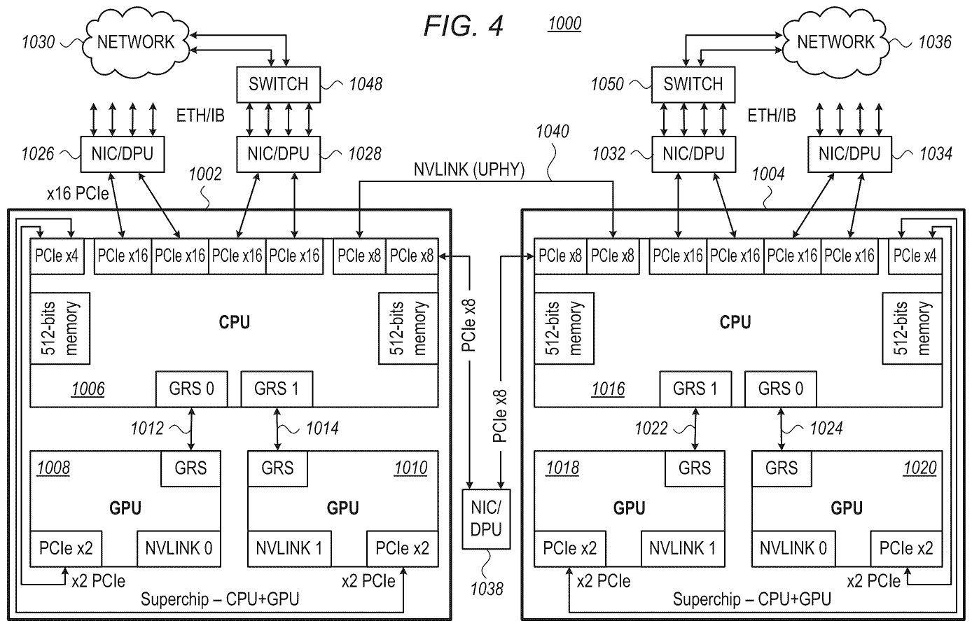

FIG. 4 is a block diagram that schematically illustrates a computing system 1000, e.g., a data center or a High-Performance Computing (HPC) cluster, which employs communication using separated transport and RDMA layers in accordance with an embodiment that is described herein. System 1000 comprises a plurality of subsystems, e.g. multiple processing devices coupled to each other, multiple network devices, and multiple networks, according to at least one embodiment. Computing system 1000 is designed with multiple integrated circuits (referred to as processing devices), where each integrated circuit can include one or more CPUs and GPUs, forming a powerful and flexible architecture.

The various processing devices are interconnected via an NVLink or other high-speed interconnect, enabling high-speed communication between the subsystems, and are also connected through a NIC or DPU to ensure efficient data transfer across computing system 1000 and to one or more external networks 1030, 1036. In the present example, system 1000 comprises a packet switch 1048 that connects NIC/DPU 1028 to network 1030, and a packet switch 1050 that connects NIC/DPU 1032 to network 1036.

The coupling of processing devices through NVLink allows for seamless data exchange and parallel processing, enhancing overall computational performance. The processing devices are connected to multiple networks through one or more network interface cards (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 1000 can include one or more CPUs and one or more GPUs.

FIG. 4 also demonstrates an example architecture of a multi-GPU architecture. As illustrated in the figure, computing system 1000 includes a processing device 1002 with a multi-GPU architecture. In particular, processing device 1002 may be a system-on-chip and includes multiple subsystems such as a CPU 1006, a GPU 1008, and a GPU 1010. CPU 1006 can be coupled to GPU 1008 via a die-to-die (D2D) or chip-to-chip (C2C) interconnect 1012, such as a Ground-Referenced Signaling interconnect (GRS interconnect). CPU 1006 can be coupled to GPU 1010 via a D2D or C2C interconnect 1014. CPU 1006 can also couple to GPU 1008 and GPU 1010 via PCIe interconnects.

CPU 1006 can be coupled to one or more NICs or DPUs, which are coupled to one or more networks. For example, as illustrated in FIG. 4, CPU 1006 is coupled to a first NIC/DPU 1026, which is coupled to a network 1030. CPU 1006 is also coupled to a second NIC/DPU 1028, which is coupled to network 1030 via switch 1048. NIC/DPU 1026 and NIC/DPU 1028 can be coupled to network 1030 over Ethernet (ETH), NVLINK or InfiniBand (IB) connections, for example.

Computing system 1000 also includes a processing device 1004 with a multi-GPU architecture. In particular, processing device 1004 includes multiple subsystems including a CPU 1016, a GPU 1018, and a GPU 1020. CPU 1016 can be coupled to GPU 1018 via an D2D or C2C interconnect 1022. CPU 1016 can be coupled to GPU 1020 via a D2D or C2C interconnect 1024. CPU 1016 can also couple to GPU 1018 and GPU 1020 via PCIe interconnects. CPU 1016 can be coupled to one or more NICs or DPUs, which are coupled to one or more networks. For example, as illustrated in FIG. 4, CPU 1016 is coupled to a first NIC/DPU 1032, which is coupled to a network 1036. CPU 1016 is also coupled to a second NIC/DPU 1034, which is coupled to network 1036 via switch 1050. NIC/DPU 1032 and NIC/DPU 1034 can be coupled to network 1036 over Ethernet (ETH), NVLINK or InfiniBand (IB) connections.

In at least one embodiment, processing device 1002 and processing device 1004 can communication with each other via a NIC/DPU 1038, such as over PCIe interconnects. Processing device 1002 and processing device 1004 can also communicate with each other over a high-bandwidth communication interconnects 1040, such as an NVLink interconnect or other high-speed interconnects.

The packet switches in FIG. 4 may comprise, for example, Nvidia Quantum-2 switches. The NICs/DPUs in the figure may comprise, for example, Nvidia Bluefield DPUs. In various embodiments, any of the NICs/DPUs may serve as an initiator network device and/or a target network device that communicate using the layer separation techniques described herein.

It will be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A communication system, comprising:
a first network device, comprising:
a Remote Direct Memory Access (RDMA) initiator, to generate an RDMA message that comprises one or more packets and specifies an RDMA operation; and
a transport requestor, to send the one or more packets over a network via one or more transport connections; and
a second network device, comprising:
a transport responder, to receive the one or more packets from the network via the one or more transport connections; and
an RDMA target, to receive the RDMA message conveyed by the one or more packets and execute the RDMA operation, wherein:
(i) the transport responder is to send to the first network device, one or more acknowledgements indicating successful reception of the one or more packets, the acknowledgements being sent independently of successful reception of the RDMA message by the RDMA target; and
(ii) the RDMA target is to send to the first network device a confirmation indicating the successful reception of the RDMA message, in addition to the acknowledgements sent by the transport responder.

2. The communication system according to claim 1, wherein the transport requestor is to retransmit at least one of the packets, in response to the acknowledgements and irrespective of the confirmation.

3. The communication system according to claim 1, wherein the RDMA initiator is to retransmit at least part of the RDMA message, in response to the confirmation and irrespective of the acknowledgements.

4. The communication system according to claim 1, wherein the RDMA target is to determine whether all the one or more packets associated with the RDMA message were received successfully, by maintaining a count of received packets associated with the RDMA message and comparing the count to an expected size of the RDMA message.

5. The communication system according to claim 1, wherein the RDMA target is to determine whether all the one or more packets associated with the RDMA message were received successfully, by tracking successful arrival of portions of the RDMA message.

6. The communication system according to claim 1, wherein the RDMA target is to determine whether all the one or more packets associated with the RDMA message were received successfully, irrespective of Packet Sequence Numbers (PSNs) specified in the packets.

7. The communication system according to claim 1, wherein:
the transport requestor is to handle multiple transport connections, and
the RDMA initiator is to execute multiple RDMA objects that generate multiple RDMA messages, and to interleave the packets of the multiple RDMA messages over the multiple transport connections.

8. The communication system according to claim 1, wherein:
the transport responder is to handle multiple transport connections, and
the RDMA target is to execute multiple RDMA objects that receive the packets of multiple RDMA messages interleaved over the multiple transport connections and receive the multiple RDMA messages.

9. The communication system according to claim 1, wherein the RDMA initiator and the RDMA target are not to protect against duplicate delivery of a packet.

10. The communication system according to claim 1, wherein the RDMA target is to retire a given RDMA message in response to finding that not all the packets associated with the given RDMA message are received within a defined timeout.

11. The communication system according to claim 1, wherein the RDMA initiator is to report completion of the RDMA message in response to receiving both (i) the acknowledgements from the transport responder and (ii) the confirmation from the RDMA target.

12. The communication system according to claim 1, wherein the transport requestor is to release packet resources upon receiving an acknowledgement from the transport responder.

13. The communication system according to claim 1, wherein the RDMA target is to release message resources upon receiving a transport-layer acknowledgement that acknowledges the confirmation.

14. A communication method, comprising:
in a first network device: (i) generating a Remote Direct Memory Access (RDMA) message that comprises one or more packets and specifies an RDMA operation, and (ii) sending the one or more packets over a network via one or more transport connections;
in a second network device: (i) receiving the one or more packets from the network via the one or more transport connections, and (ii) receiving the RDMA message conveyed by the one or more packets and executing the RDMA operation;
sending, from the second network device to the first network device, one or more acknowledgements indicating successful reception of the one or more packets, the acknowledgements being sent independently of successful reception of the RDMA message; and
sending, from the second network device to the first network device, in addition to the acknowledgements, a confirmation indicating the successful reception of the RDMA message.

15. The communication method according to claim 14, wherein and comprising retransmitting at least one of the packets from the first network device in response to the acknowledgements and irrespective of the confirmation.

16. The communication method according to claim 14, and comprising retransmitting at least part of the RDMA message from the first network device in response to the confirmation and irrespective of the acknowledgements.

17. The communication method according to claim 14, and comprising, in the second network device, determining whether all the one or more packets associated with the RDMA message were received successfully, by maintaining a count of received packets associated with the RDMA message and comparing the count to an expected size of the RDMA message.

18. The communication method according to claim 14, and comprising, in the first network device:
handling multiple transport connections, and
executing multiple RDMA objects that generate multiple RDMA messages, and interleaving the packets of the multiple RDMA messages over the multiple transport connections.

19. The communication method according to claim 14, and comprising, in the first network device:
handling multiple transport connections, and
executing multiple RDMA objects that receive the packets of multiple RDMA messages interleaved over the multiple transport connections and receive the multiple RDMA messages.

20. A communication method, comprising:
in an initiator network device (i) in a Remote Direct Memory Access (RDMA) layer, generating an RDMA message that comprises one or more packets and specifies an RDMA operation, and (ii) in a transport layer, sending the one or more packets over a network via one or more transport connections; and
in a target network device, (i) in the transport layer, receiving the one or more packets from the network via the the one or more transport connections, and (ii) in the RDMA layer, receiving the RDMA message conveyed by the one or more packets, and executing the RDMA operation,
wherein the RDMA layer and the transport layer are independent of one another, both in the initiator network device and in the target network device.
